(19) United States
(12) Patent Application Publication
(10) Pub. No.: US 2009/0286112 A1
(43) Pub. Date: Nov. 19, 2009

(54) METHOD FOR ACCELERATING ACTIVATION OF FUEL CELL

(75) Inventors: Seung Chan Oh, Gyeonggi-do (KR); Jae Jun Ko, Gyeonggi-do (KR); Young Min Kim, Gyeonggi-do (KR); Ik Jae Son, Gyeonggi-do (KR); Jong Hyun Lee, Gyeonggi-do (KR); Jong Jin Yoon, Seoul (KR)

Correspondence Address: EDWARDS ANGELL PALMER & DODGE LLP, P.O. BOX 55874, BOSTON, MA, 02205, US

(73) Assignees: HYUNDAI MOTOR COMPANY, Seoul (KR); KIA MOTORS CORPORATION

(21) Appl. No.: 12/268,079

(22) Filed: Nov. 10, 2008

(30) Foreign Application Priority Data
May 15, 2008 (KR) 10-2008-0044894

(51) Int. Cl. H01M 8/04

(52) U.S. Cl. 429/13; 429/12

(57) ABSTRACT

The present invention provides a method for accelerating activation of a fuel cell, which can significantly reduce the time required for the activation of the fuel cell and the amount of hydrogen used and facilitate the activation of the fuel cell.

### CROSS-REFERENCE TO RELATED APPLICATION

This application claims under 35 U.S.C. §119(a) the benefit of Korean Patent Application No. 10-2008-44894 filed May 15, 2008, the entire contents of which are incorporated herein by reference.

### BACKGROUND

(a) Technical Field

The present invention relates to a method for accelerating the activation of a fuel cell. More particularly, the present invention relates to a method for accelerating the activation of a fuel cell, wherein the method can reduce the time required for the activation of the fuel cell and the amount of hydrogen used and facilitate the activation of the fuel cell.

(b) Background Art

In general, a fuel cell is a device that generates electrical energy through an electrochemical reaction between hydrogen (H₂) and oxygen (O₂) and includes a membrane electrode assembly (MEA).

As shown in FIG. 6, the MEA can include a fuel electrode 12 (anode) to which hydrogen is supplied, an air electrode 14 (cathode) to which air is supplied, an electrolyte membrane 10 transporting hydrogen ions, interposed between the fuel electrode 12 and the air electrode 14, and a gas diffusion layer (GDL) 16 disposed on the outside of the fuel electrode 12 and the air electrode 14, which can include a catalyst layer, respectively. A fuel cell stack is generally formed by sequentially stacking the MEA and a separator.

The principle of electricity generation of the fuel cell stack will now be described with reference to FIG. 6. When hydrogen as a fuel is supplied to the fuel electrode 12 and oxygen as an oxidant is supplied to the air electrode 14, the hydrogen supplied to the fuel electrode 12 is dissociated into hydrogen ions (H+) and electrons (e−) by an oxidation reaction on the catalyst layer. Accordingly, the thus generated hydrogen ions move to the air electrode 14 through the electrolyte membrane 10 and the electrons are transferred to the air electrode 14 through an external circuit. As a result, at the air electrode 14, the supplied oxygen combines with electrons to produce oxygen ions by a reduction reaction on the catalyst layer, and the hydrogen ions combine with the oxygen ions to produce water, thus generating electricity.

In case of a newly fabricated fuel cell stack having the above-described configuration and principle of electricity generation, the degree of activation in the electrochemical reaction is reduced during initial operation. Accordingly, in order to achieve the optimum performance during initial operation, an activation process is usually performed.

Preferred objectives of the fuel cell activation process, which is also called pre-conditioning or break-in, are to remove residual impurities introduced during manufacturing of the MEA and the fuel cell stack, to activate catalyst metal reaction sites that cannot participate in the reaction, to ensure a transfer path of the reactants to the catalyst, and to ensure a hydrogen ion transfer path by sufficiently hydrating the electrolyte contained in the electrolyte membrane and the electrodes.

Considerations for the activation of the fuel cell include catalyst reaction acceleration, membrane hydration, electrical contact surface formation, and triple phase boundary formation.

Catalyst reaction acceleration occurs to reduce oxidized platinum (PtₓO_{y}→Pt metal), and includes a reduction method using a capacitance-voltage (CV) scan and a reduction method of exposing the catalyst to hydrogen gas.

Membrane hydration is carried out to improve conductivity of hydrogen ions, in which water molecules are present inside the pores of the membrane to facilitate the transfer of hydrogen ions.

Electrical contact surface formation is performed to reduce electrical contact resistance at the interface between the respective electrodes and the GDL or at the interface between the GDL and the membrane.

Triple phase boundary formation is performed to accelerate the electrochemical reaction by forming a boundary between the electrolyte, electrode catalyst and reactant gases.

Regarding the conventional methods for the activation of the fuel cell, there is an activation method by a constant voltage operation and a cycle operation that is commonly used in the art; however, in using this method, the activation time is increased, the amount of hydrogen used is large, and the equipment for the activation is complicated.

Conventional methods for overcoming some of the above-described challenges of the general activation methods include: (1) U.S. Pat. No. 7,078,118, issued to UTC Fuel Cells, disclosing a method for controlling reactant gases by applying a direct current; (2) Japanese Patent Publication No. 2004-349050, issued to Aisin Seiki Co., Ltd., disclosing an activation method by a constant current mode operation; (3) U.S. Pat. No. 6,896,982, issued to Ballard Power Systems Inc., disclosing a conditioning method for fuel cells in which a catalyst at a cathode is exposed to hydrogen gas to be reduced; (4) U.S. Pat. No. 5,601,936, issued to British Gas plc, disclosing a method of activating a fuel cell by applying a voltage using a battery; and (5) U.S. Pat. No. 6,576,356, issued to Plug Power Inc., disclosing a preconditioning method by membrane hydration.

However, the above conventional methods have the following considerations.

(1) Regarding the method for controlling reactant gases by applying a direct current, since the reactant gas should be changed from air to nitrogen, the process is complicated, and an additional device for supplying nitrogen is required.

(2) Regarding the activation method by the constant current mode operation, it is also necessary to supply nitrogen and thus additional equipment for supplying nitrogen is required.

(3) Regarding the conditioning method for fuel cells in which a catalyst at a cathode is exposed to hydrogen gas to be reduced, if air is supplied to the cathode, from which hydrogen is not completely removed, the catalyst may be damaged and, in order to completely remove the remaining hydrogen, it is necessary to purge the cathode with an inert gas such as nitrogen.

(4) Regarding the method of activating a fuel cell by applying a voltage using a battery, it is necessary to provide a galvanic cell and a capacitor as well as the battery, thus the system is complicated.

(5) Regarding the preconditioning method by membrane hydration, it is necessary to use an inert gas such as nitrogen instead of air, and an additional activation process must be performed after completion of a hydration process, and thus the system is complicated and the activation time is increased.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

In one aspect, the present invention provides a method for accelerating activation of a fuel cell, which can considerably reduce the time required for the activation of the fuel cell and the amount of hydrogen used for the activation without any additional equipment, thus eliminating the need for an MEA hydration process and an activation pretreatment process, reducing the activation time, and thus reducing the amount of hydrogen used that is typically increased with the increase in the activation time, and eliminating the need for a battery and additional equipment for supplying nitrogen that are typically required.

In one embodiment, the present invention provides a method for accelerating activation of a fuel cell, the method comprising: a first step of preferably supplying hydrogen to a fuel electrode of a fuel cell and air to an air electrode of the fuel cell and suitably maintaining a cell voltage at an opening-circuit voltage of a predetermined level; a second step of preferably cutting off air supply to the air electrode; a third step of preferably reducing the cell voltage from the predetermined level of the opening-circuit voltage to a threshold level after suitably cutting off the air supply to the air electrode; a fourth step of preferably supplying air to the air electrode again to suitably increase the opening-circuit voltage to the predetermined level when the opening-circuit voltage is preferably reduced to the threshold level; a fifth step of preferably supplying a sufficient amount of hydrogen and air to the fuel electrode and the air electrode, respectively, and suitably operating the fuel cell in a constant current or constant voltage operation mode; and preferably a sixth step of suitably repeating the first to fifth steps for a predetermined number of times.

In another preferred embodiment, in the first and fourth steps, the opening-circuit voltage of the predetermined level is preferably 0.95 to 1.2 V and, in the first step, the opening-circuit voltage of the predetermined level is suitably maintained for several seconds.

In another preferred embodiment, in the third step, the opening-circuit voltage of the threshold level is preferably 0.2 V.

In still another preferred embodiment, in the fifth step, an operation voltage of the constant current or constant voltage operation mode is preferably 0.1 to 0.8 V per fuel cell.

In yet another preferred embodiment, the operation voltage of the constant current or constant voltage operation mode is preferably 0.1 to 0.6 V per fuel cell.

In still yet another preferred embodiment, in the sixth step, the first to fifth steps are preferably repeated 30, 40, 45, 50, 55, 60, 65 to 70 or more times for a time between 45, 50, 55, 60, 65, to 70 minutes.

In another aspect, the present invention provides a method for accelerating activation of a fuel cell, the method comprising: a first step of preferably supplying hydrogen to a fuel electrode of a fuel cell and air to an air electrode of the fuel cell and suitably maintaining a cell voltage at a predetermined level, which is lower than an opening-circuit voltage, by suitably applying a current load; a second step of preferably cutting off air supply to the air electrode; a third step of preferably reducing the cell voltage to a threshold level after cutting off the air supply to the air electrode; a fourth step of preferably supplying air to the air electrode again and increasing the opening-circuit voltage to the predetermined level by suitably applying a current load when the opening-circuit voltage is reduced to the threshold level; a fifth step of preferably supplying a sufficient amount of hydrogen and air to the fuel electrode and the air electrode, respectively, and operating the fuel cell in a constant current or constant voltage operation mode; and a sixth step of repeating the first to fifth steps for a predetermined number of times.

In a preferred embodiment, in the first and fourth steps, the cell voltage is preferably 0.8 to 1.23 V, which is lower than the opening-circuit voltage.

In another preferred embodiment, in the third step, the cell voltage of the threshold level is preferably 0.2 V.

In still another preferred embodiment, in the fifth step, an operation voltage of the constant current or constant voltage operation mode is preferably 0.1 to 0.8 V per fuel cell.

In yet another preferred embodiment, the operation voltage of the constant current or constant voltage operation mode is preferably 0.1 to 0.6 V per fuel cell.

In still yet another preferred embodiment, in the sixth step, the first to fifth steps are preferably repeated 30, 40, 45, 50, 55, 60, 65 to 70 or more times for a time between 45, 50, 55, 60, 65, to 70 minutes.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum).

As referred to herein, a hybrid vehicle is a vehicle that has two or more sources of power, for example both gasoline-powered and electric-powered.

The above features and advantages of the present invention will be apparent from or are set forth in more detail in the accompanying drawings, which are incorporated in and form a part of this specification, and the following Detailed Description, which together serve to explain by way of example the principles of the present invention.

### BRIEF DESCRIPTION OF THE DRAWINGS

The above and other features of the present invention will now be described in detail with reference to certain exemplary embodiments thereof illustrated by the accompanying drawings which are given hereinbelow by way of illustration only, and thus are not limitative of the present invention, and wherein:

FIG. 1 is a flowchart illustrating a method for accelerating activation of a fuel cell in accordance with the present invention;

FIG. 2 is a graph illustrating the method for accelerating activation of a fuel cell in accordance with the present invention;

FIG. 3 is a graph illustrating a conventional activation method only by a constant voltage or constant current operation;

FIG. 4 is a graph illustrating a conventional activation method by a cycle operation mode;

FIG. 5 is a graph illustrating the results of activation processes performed by a conventional activation method and the activation method of the present invention; and

FIG. 6 is a schematic diagram illustrating a fuel cell and its operation principle.

Reference numerals set forth in the Drawings includes reference to the following elements as further discussed below:
10: electrolyte membrane
12: fuel electrode
14: air electrode
16: gas diffusion layer

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

As described herein, the present invention includes a method for accelerating activation of a fuel cell, the method comprising supplying hydrogen to a fuel electrode of a fuel cell and air to an air electrode of the fuel cell and maintaining a cell voltage at a predetermined level, which is lower than an opening-circuit voltage; cutting off air supply to the air electrode; reducing the cell voltage to a threshold level after cutting off the air supply to the air electrode; supplying air to the air electrode again and increasing the opening-circuit voltage to the predetermined level; and supplying a sufficient amount of hydrogen and air to the fuel electrode and the air electrode, respectively.

In one embodiment of the method, supplying hydrogen to a fuel electrode of a fuel cell and air to an air electrode of the fuel cell is carried out by applying a current load.

In another embodiment of the method, supplying air to the air electrode again and increasing the opening-circuit voltage to the predetermined level is carried out by applying a current load.

In still another embodiment of the method, the current load is applied when the opening-circuit voltage is reduced to the threshold level. In a further embodiment, the fuel cell is operated in a constant current or constant voltage operation mode

In another embodiment of the method, supplying hydrogen to a fuel electrode of a fuel cell and air to an air electrode of the fuel cell and maintaining a cell voltage at a predetermined level and supplying a sufficient amount of hydrogen and air to the fuel electrode and the air electrode, respectively, and operating the fuel cell in a constant current or constant voltage operation mode, are repeated for a predetermined number of times.

The invention can also include a motor vehicle comprising a fuel cell activated by the method of claim 1.

Hereinafter reference will be made in detail to various embodiments of the present invention, examples of which are illustrated in the accompanying exemplary drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

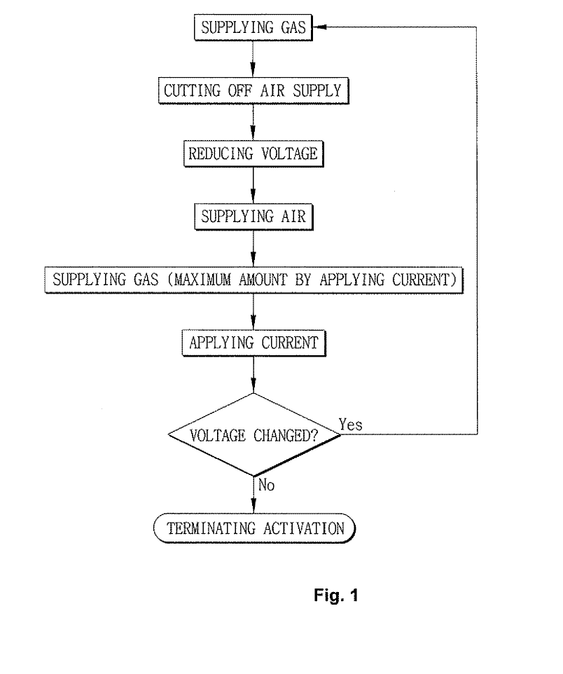

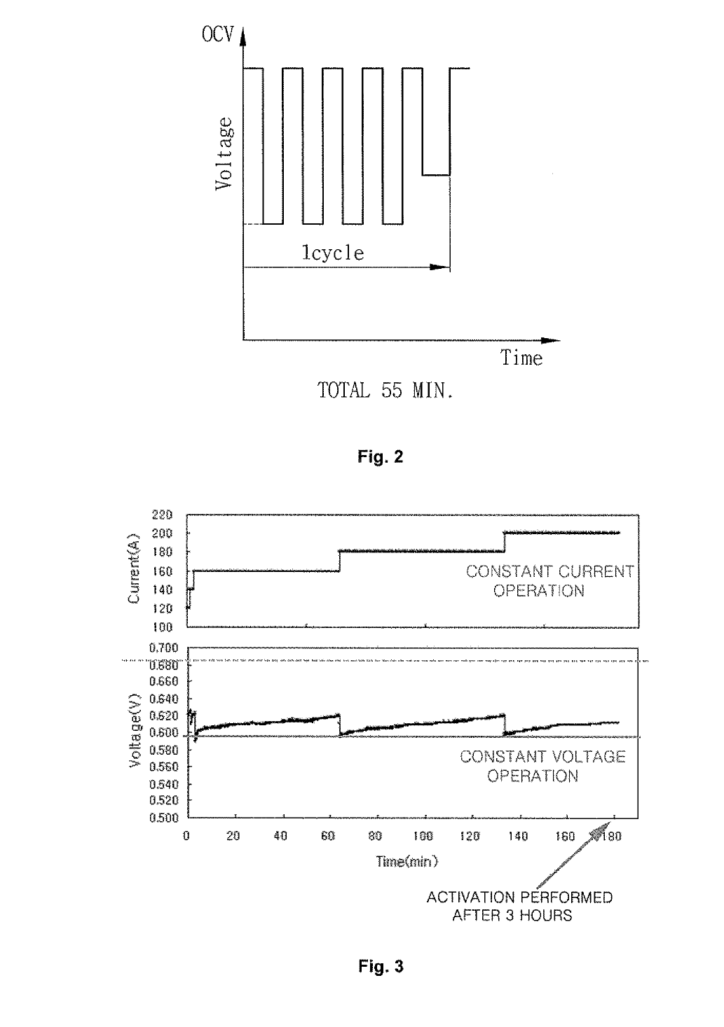

FIG. 1 is a flowchart illustrating a preferred method for accelerating activation of a fuel cell in accordance with the present invention, and FIG. 2 is a graph thereof.

As shown in FIGS. 1 and 2, a preferred method for accelerating activation of a fuel cell in accordance with the present invention is suitably performed in such a manner that air is preferably supplied or is not supplied to a fuel cell, a cell voltage is suitably increased or decreased, and a constant current or constant voltage operation mode suitably continues until there is no voltage change.

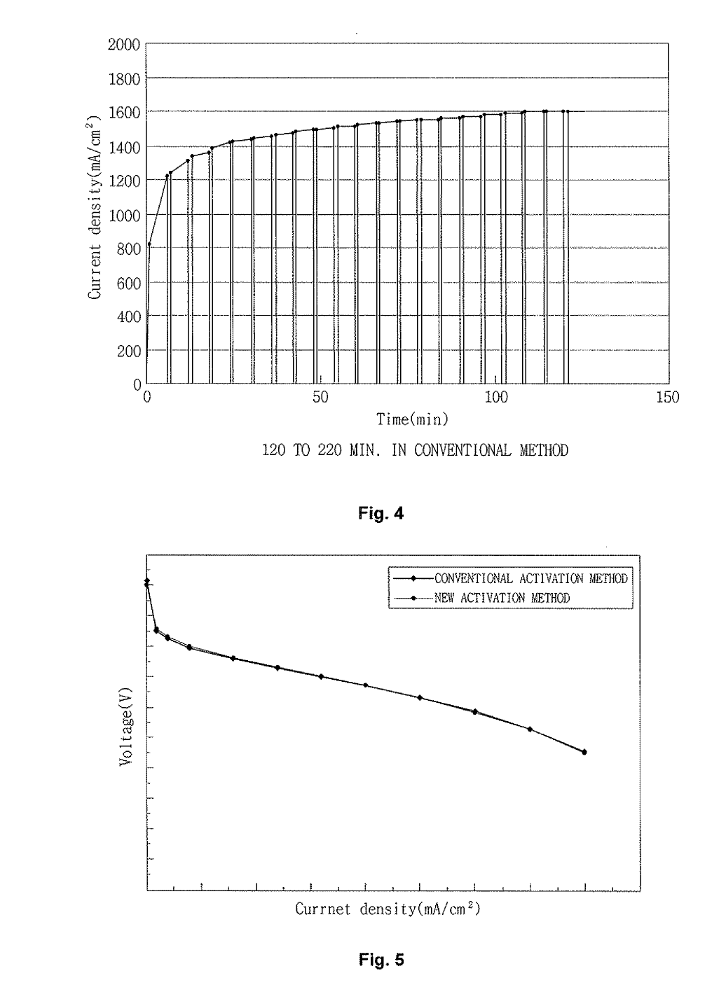

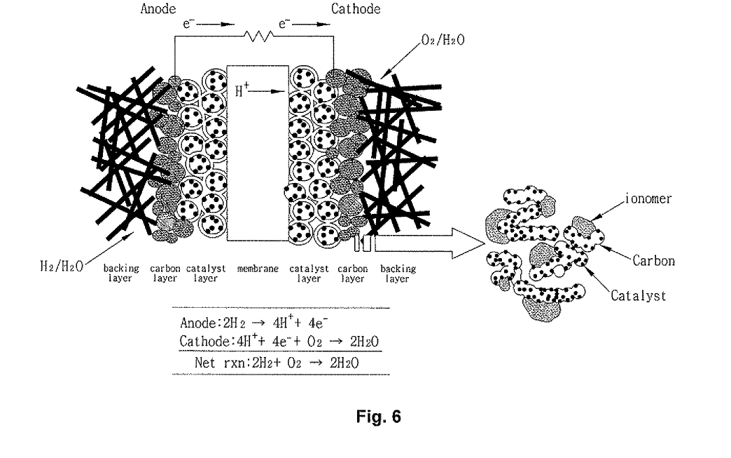

The above-described exemplary method for accelerating activation of a fuel cell in accordance with the present invention is performed for about 55 minutes. Accordingly, it is possible to considerably reduce the activation time and the amount of hydrogen used according to the reduction in the activation time, for example when compared with a conventional activation method by a cycle operation mode under load conditions given to the fuel cell (refer to FIG. 4), in which the activation time is about 120 to 220 minutes, and a conventional activation method by a constant current or constant voltage operation mode, in which the activation time is about 3 hours.

As shown in the graph of FIG. 5, a preferred method for accelerating activation of a fuel cell in accordance with the present invention shows activation results that are comparable to the activation results obtained with the conventional activation methods; however the preferred method according to the invention as described herein features the reduction in the activation time.

### EXAMPLES

The following examples illustrate the invention and are not intended to limit the same.

### Example 1

In preferred embodiments, as a first step, hydrogen is preferably supplied to a fuel electrode of a fuel cell and, at the same time, oxygen is preferably supplied to an air electrode of the fuel cell; however, the amounts are considerably small, and a cell voltage is suitably maintained at an open-circuit voltage (OCV) of 0.95 to 1.2 V for 10 to 20 seconds.

In preferred embodiments, as a second step, the air supply to the air electrode is suitably cut off and, preferably, as a third step, after the air supply to the air electrode is cut off, the cell voltage is suitably reduced from the OCV of 0.95 to 1.2 V to a threshold level, i.e., to 0.2 V.

In preferred embodiments, as a fourth step, when the cell voltage is preferably reduced to the threshold voltage, 0.2 V, air is preferably supplied to the air electrode again to suitably increase the cell voltage to the OCV of 0.95 to 1.2 V.

In further preferred embodiments, a fifth step of preferably supplying a sufficient amount of hydrogen and air to the fuel electrode and the air electrode, respectively, and preferably operating the fuel cell in a constant current or constant voltage operation mode is suitably performed.

Accordingly, the operation voltage of the constant current or constant voltage operation mode is preferably between 0.1 to 0.8 V per fuel cell, in which 0.8 V represents a voltage when a minimally required current is applied and 0.1 V represents a voltage at a maximum operation region.

Preferably, the operation voltage of the constant current or constant voltage operation mode is between 0.1 V, a voltage at a suitable maximum operation region, and 0.6 V, a voltage when a suitable minimally required current is applied, per fuel cell.

In further preferred embodiments, as a sixth step, the first to fifth steps are repeatedly performed 30, 40, 45, 50, 55, 60, 65 to 70 or more times, preferably 50 to 60 times, for 45, 50, 55, 60, 65, to 70 minutes, preferably 55 to 60 minutes and continue until there is no change in the cell voltage.

### Example 2

In preferred embodiments, as a first step, hydrogen and air are preferably supplied to a fuel electrode and an air electrode of a fuel cell, and a current load is preferably applied to the fuel cell so as to maintain a suitable cell voltage of the fuel cell at 0.8 to 1.23 V, which is lower than an open-circuit voltage (OCV).

In certain embodiments, since the OCV of the most commonly used cells is close to 0.9 V, the voltage may be suitably maintained at 0.8 V when a small amount of current is applied, and 1.23 V represents a theoretical voltage.

In other embodiments, as a second step, the air supply to the air electrode is preferably cut off and, preferably as a third step, after the air supply to the air electrode is cut off, the cell voltage is suitably reduced to 0.2 V, a threshold level.

Accordingly, in other embodiments, in a case where the air supply is suitably cut off and only hydrogen is preferably supplied to the fuel electrode, the cell voltage is suitably maintained at 0 to 0.2 V.

In further embodiments, as a fourth step, when the cell voltage is preferably reduced to the threshold voltage, air is preferably supplied to the air electrode and the current load is suitably applied to the fuel cell again to increase the cell voltage to 0.8 to 1.23 V.

In further embodiments, a fifth step of supplying a suitably sufficient amount of hydrogen and air to the fuel electrode and the air electrode, respectively, and preferably operating the fuel cell in a constant current or constant voltage operation mode is performed.

Accordingly, the operation voltage of the constant current or constant voltage operation mode is suitably between 0.1 to 0.8 V per fuel cell, in which 0.8 V represents a preferred voltage when a minimally required current is applied and 0.1 V represents a preferred voltage at a maximum operation region.

Preferably, the operation voltage of the constant current or constant voltage operation mode is between 0.1 V, a voltage at a preferred maximum operation region, and 0.6 V, a voltage when a minimally required current is suitably applied, per fuel cell.

In further embodiments, as a sixth step, the first to fifth steps are repeatedly performed 30, 40, 45, 50, 55, 60, 65 to 70 or more times, preferably 50 to 60 times for 45, 50, 55, 60, 65, to 70 minutes, preferably 55 to 60 minutes, and continue until there is no change in the cell voltage.

In one example, the activation time and the amount of hydrogen used in accordance with the examples of the present invention were compared with those of the conventional activation method using a load cycle, and the results are shown in the following table 1.

TABLE 1

| | Conventional method | |
|---|---|---|
| Classification | (for vehicle) | Present invention |
| Process | Load cycle (CC mode) | Modified potential |
| | | cycle + constant current |
| | | (CC mode) |
| Activation time (min) | 90 | 55 |
| Activation degree (%) | 95 to 98 | 100 |
| Amount of hydrogen | 202.6 | 108.4 |
| used (liter) | | |

As shown in Table 1, the present invention can considerably reduce the activation time of the fuel cell and thus, accordingly, the amount of hydrogen used, compared with the conventional activation method by the load cycle.

As described above, according to preferred methods for accelerating activation of the fuel cell of the present invention, preferably including supplying hydrogen and air to the fuel electrode and the air electrode of the fuel cell, respectively, suitably cutting off the air supply to the air electrode at a predetermined point of time, suitably reducing the cell voltage, suitably supplying air to the air electrode again to increase the cell voltage to the original level, and preferably supplying hydrogen and air to the fuel electrode and the air electrode and operating the fuel cell in the constant current or constant voltage operation mode, it is possible to considerably reduce the activation time of the fuel cell and, accordingly, the amount of hydrogen used, without any additional equipment.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A method for accelerating activation of a fuel cell, the method comprising:
a first step of supplying hydrogen to a fuel electrode of a fuel cell and air to an air electrode of the fuel cell and maintaining a cell voltage at an opening-circuit voltage of a predetermined level;
a second step of cutting off air supply to the air electrode;
a third step of reducing the cell voltage from the predetermined level of the opening-circuit voltage to a threshold level after cutting off the air supply to the air electrode;
a fourth step of supplying air to the air electrode again to increase the opening-circuit voltage to the predetermined level when the opening-circuit voltage is reduced to the threshold level;
a fifth step of supplying a sufficient amount of hydrogen and air to the fuel electrode and the air electrode, respectively, and operating the fuel cell in a constant current or constant voltage operation mode; and
a sixth step of repeating the first to fifth steps for a predetermined number of times.

2. A method for accelerating activation of a fuel cell, the method comprising:
a first step of supplying hydrogen to a fuel electrode of a fuel cell and air to an air electrode of the fuel cell and maintaining a cell voltage at a predetermined level, which is lower than an opening-circuit voltage, by applying a current load;
a second step of cutting off air supply to the air electrode;
a third step of reducing the cell voltage to a threshold level after cutting off the air supply to the air electrode;
a fourth step of supplying air to the air electrode again and increasing the opening-circuit voltage to the predetermined level by applying a current load when the opening-circuit voltage is reduced to the threshold level;
a fifth step of supplying a sufficient amount of hydrogen and air to the fuel electrode and the air electrode, respectively, and operating the fuel cell in a constant current or constant voltage operation mode; and
a sixth step of repeating the first to fifth steps for a predetermined number of times.

3. The method of claim 1, wherein, in the first and fourth steps, the opening-circuit voltage of the predetermined level is 0.95 to 1.2 V, the cell voltage is 0.8 to 1.23 V, which is lower than the opening-circuit voltage and, in the first step, the opening-circuit voltage of the predetermined level is maintained for several seconds.

4. The method of claim 1, wherein, in the third step, the opening-circuit voltage of the threshold level is 0.2 V, and the cell voltage of the threshold level is 0.2 V.

5. The method of claim 1, wherein, in the fifth step, an operation voltage of the constant current or constant voltage operation mode is 0.1 to 0.8 V per fuel cell.

6. A method for accelerating activation of a fuel cell, the method comprising:
supplying hydrogen to a fuel electrode of a fuel cell and air to an air electrode of the fuel cell and maintaining a cell voltage at a predetermined level, which is lower than an opening-circuit voltage;
cutting off air supply to the air electrode;
reducing the cell voltage to a threshold level after cutting off the air supply to the air electrode;
supplying air to the air electrode again and increasing the opening-circuit voltage to the predetermined level; and
supplying a sufficient amount of hydrogen and air to the fuel electrode and the air electrode, respectively.

7. The method of claim 6, wherein the supplying hydrogen to a fuel electrode of a fuel cell and air to an air electrode of the fuel cell is carried out by applying a current load.

8. The method of claim 6, wherein the supplying air to the air electrode again and increasing the opening-circuit voltage to the predetermined level is carried out by applying a current load.

9. The method of claim 8, wherein the current load is applied when the opening-circuit voltage is reduced to the threshold level.

10. The method of claim 6, wherein the fuel cell is operated in a constant current or constant voltage operation mode

11. The method of claim 6, wherein supplying hydrogen to a fuel electrode of a fuel cell and air to an air electrode of the fuel cell and maintaining a cell voltage at a predetermined level and supplying a sufficient amount of hydrogen and air to the fuel electrode and the air electrode, respectively, and operating the fuel cell in a constant current or constant voltage operation mode, are repeated for a predetermined number of times.

12. A motor vehicle comprising a fuel cell activated by the method of claim 1.

13. A motor vehicle comprising a fuel cell activated by the method of claim 6.

14. The method of claim 2, wherein, in the first and fourth steps, the opening-circuit voltage of the predetermined level is 0.95 to 1.2 V, the cell voltage is 0.8 to 1.23 V, which is lower than the opening-circuit voltage and, in the first step, the opening-circuit voltage of the predetermined level is maintained for several seconds.

15. The method of claim 2, wherein, in the third step, the opening-circuit voltage of the threshold level is 0.2 V, and the cell voltage of the threshold level is 0.2 V.

16. The method of claim 2, wherein, in the fifth step, an operation voltage of the constant current or constant voltage operation mode is 0.1 to 0.8 V per fuel cell.
